(19) United States
(12) Patent Application Publication
(10) Pub. No.: US 2006/0154543 A1
(43) Pub. Date: Jul. 13, 2006

(54) Composite laminate and rigid molded article made from the same

(76) Inventor: Ten-Po Shao, Tainan Hsien (TW)

Correspondence Address: FROMMER LAWRENCE & HAUG, 745 FIFTH AVENUE- 10TH FL., NEW YORK, NY, 10151, US

(21) Appl. No.: 11/350,689

(22) Filed: Feb. 9, 2006

Related U.S. Application Data
(63) Continuation-in-part of application No. 10/759,842, filed on Jan. 16, 2004.

(51) Int. Cl. B32B 17/02; B32B 5/02; B32B 27/12; D03D 15/00

(52) U.S. Cl. 442/172; 442/286; 442/288; 442/287; 442/301; 442/179; 442/180

(57) ABSTRACT

A composite laminate includes a fabric sheet which is surface-treated with an amine-containing surface agent, a thermoplastic sheet, and a polyurethane elastomer film interposed between the fabric sheet and the thermoplastic sheet, and penetrating into and through the fabric sheet so as to react with the surface agent on the fabric sheet and so as to be bonded to the thermoplastic sheet in an amount such that the composite laminate has a Barcol's hardness ranging from HBI-A6 to HBI-A16, a flexure strength ranging from 30 to 250N/mm² a flexure modulus ranging from 700 to 5000 N/mm², and an impact resistance ranging from 100 to 800 J/m.

### CROSS-REFERENCE TO RELATED APPLICATION

This application is a continuation-in-part (CIP) of U.S. patent application Ser. No. 10/759,842, filed by the applicant on Jan. 16, 2004,

### BACKGROUND OF THE INVENTION

1. Field of the Invention

This invention relates to a composite laminate, more particularly to a composite laminate having a fabric sheet bonded to a thermoplastic sheet through a polyurethane elastomer film.

2. Description of the Related Art

Rigid articles, such as the housing of a computer or a cellular phone, are normally made from a composite laminate that includes a carbon fiber-made fabric laminate consisting of a plurality of fabric sheets, each of which is impregnated with epoxy resin The fabric laminate is subsequently coated with a polyurethane layer thereon by spraying repeatedly polyurethane thereto so as to obtain a smooth surface on the fabric sheet.

Another conventional composite laminate includes a fabric sheet, a thermoplastic sheet adhesively bended to one side of the fabric sheet through an adhesive, and a polyurethane film coated on an opposite side of the fabric sheet to obtain a smooth surface on the opposite side of the fabric sheet.

The aforesaid conventional composite laminates are disadvantageous in that production thereof is time-consuming, and is relatively expensive.

### SUMMARY OF THE INVENTION

Therefore, the object of the present invention is to provide a composite laminate that is capable of overcoming the aforesaid drawbacks of the prior art.

According to the present invention, there is provided a composite laminate that includes: a fabric sheet which is surface-treated with an amine-containing surface agent; a thermoplastic sheet; and a polyurethane elastomer film interposed between the fabric sheet and the thermoplastic sheet, and penetrating into and through the fabric sheet so as to react with the surface agent on the fabric sheet and so as to be bonded to the thermoplastic sheet in an amount such that the composite laminate has a Barcol's hardness ranging from HBI-A6 to HBI-A16, a flexure strength ranging from 30 to 250N/mm² a flexure modulus ranging from 700 to 5000 N/mm², and an impact resistance ranging from 100 to 800 J/m.

### BRIEF DESCRIPTION OF THE DRAWINGS

In drawings which illustrate an embodiment of the invention,

FIG. 1 is a flow diagram illustrating consecutive steps of the preferred embodiment of a method for making a composite laminate according to the present invention;

FIG. 2 is a fragmentary sectional view of the composite laminate formed according to the embodiment of the method of this invention; and

FIG. 3 is a perspective view of an article made from the composite laminate of this invention.

### DETAILED DESCRIPTION OF THE PREFERRED EMBODIMENT

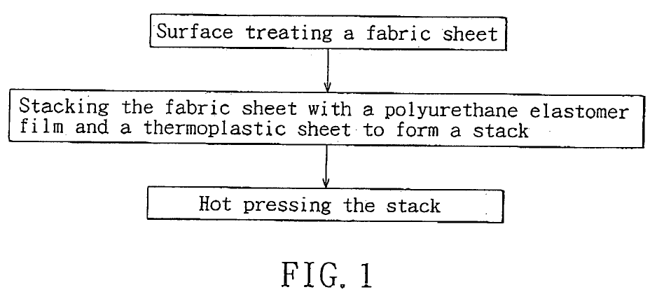

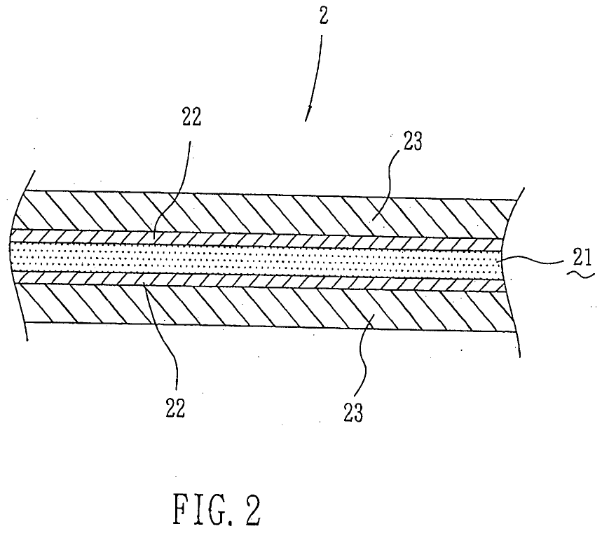

FIGS. 1 and 2 illustrate the preferred embodiment of a method for making a composite laminate 2 according to the present invention.

The method of this invention includes the steps of: surface-treating a fabric sheet 21 with an amine-containing surface agent by impregnating the fabric sheet 21 in a solution containing the amine-containing surface agent; stacking the surface-treated fabric sheet 21 with two polyurethane elastomer (TPU) films 22 and two thermoplastic sheets 23 to form a stack (see FIG. 2), each polyurethane elastomer film 22 being disposed between the fabric sheet 21 and a respective one of the thermoplastic sheets 23 (note that when only one thermoplastic sheet 23 is used, one of the polyurethane films 22 will be exposed to the atmosphere and forms a smooth surface on the fabric sheet 21); and hot pressing the stack in such a manner so as to permit penetration of each polyurethane elastomer film 22 into the fabric sheet 21, reaction of each polyurethane elastomer film 22 with the surface agent to form a —CONH bonding therebetween, and adhesive bonding of each polyurethane elastomer film 22 to the respective thermoplastic sheet 23. In this embodiment, the hot pressing is conducted at a temperature ranging from 120-180° C., a pressing pressure ranging from 2-10 Kg/cm², and a pressing time ranging from 60-250 seconds. Penetration of the polyurethane elastomer film 22 into and through the fabric sheet 21 is in an amount such that the composite laminate 2 has a Barcol's hardness ranging from HBI-A6 to HBI-A16, a flexure strength ranging from 30 to 250 N/mm², a flexure modulus ranging from 700 to 5000 N/mm². and an impact resistance ranging from 100 to 800 J/m.

Preferably, each thermoplastic sheet 23 is made from a material selected from the group consisting of polyvinyl chloride, acrylonitrile-butadiene-styrene copolymer, polystyrene, polycarbonate, and polyester, and has a thickness ranging from 0-5 to 3 mm.

The fabric sheet 21 is preferably made from synthetic fibers, carbon fiber, and glass fiber, and is more preferably made from carbon fiber.

The amine-containing surface agent can contain monoamines, diamines, or triamines. Preferably, the amine-containing surface agent contains a diamine compound.

Table 1 shows mechanical properties of the composite laminate 2 of this invention.

TABLE 1

| | | | | | | | | Impact | |
|---|---|---|---|---|---|---|---|---|---|
| | | | | Flexure (ASTM D790) | | | | Resistance | |
| | | Hardness | | Strength | | Modulus | | (ASTM D256) | |
| | Thickness | Barcol number | | (N/mm′) | | (N/mm′) | | (J/m) | |
| | mm | Min | Max | Min | Max | Min | Max | Min | Max |
| 1.0 mm PET/SilverMesh | 1.51˜1.58 | HBI-A6 | HBI-A14 | 38 | 93 | 712 | 1893 | — | — |
| 1.0 mm PET/SilverGlass | 1.33˜1.38 | HBI-A6 | HBI-A14 | 44 | 99 | 964 | 2990 | — | — |
| 3.0 mm PET/Silver Glass | 3.17˜3.20 | HBI-A6 | HBI-A14 | — | — | — | — | 100 | 250 |
| 0.5 mm PC/SilverMesh | 0.98˜1.02 | HBI-A7 | HBI-A16 | 54 | 125 | 1040 | 2610 | — | — |
| 1.0 mm PC/SilverMesh | 1.49˜1.51 | HBI-A7 | HBI-A16 | 57 | 138 | 930 | 2290 | — | — |
| 0.5 mm PC/SilverGlass | 0.96˜1.02 | HBI-A7 | HBI-A16 | 62 | 155 | 1190 | 3550 | — | — |
| 1.0 mm PC/SilverGlass | 1.43˜1.48 | HBI-A7 | HBI-A16 | 67 | 163 | 1412 | 3622 | — | — |
| 3.0 mm PC/SilverGlass | 3.19˜3.23 | HBI-A7 | HBI-A16 | 70 | 220 | 1496 | 4940 | 308 | 710 |

The silver mesh and the silver glass (which is made from glass fiber) in Table 1 represent the fabric sheet 21 woven into a web. Barcol's Hardness test method (ASTM D2583) is used to determine the hardness of reinforced and non-reinforced rigid plastics.

When the Barcol'a hardness value of the composite laminate 2 is lower than HBI-A6, the composite laminate. 2 is too soft and is not suitable for producing rigid articles that can achieve protecting purposes.

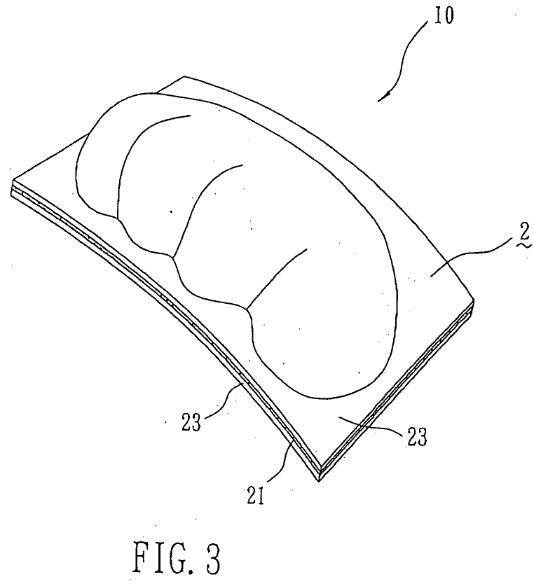

FIG. 3 illustrates a rigid molded article 10 made from the composite laminate 2 of this invention. The composite laminate 2 is cut into a predetermined size, and is subsequently subjected to compression molding in a mold (not shown) under a molding temperature ranging from 100-130° C., a molding pressure ranging from 2-10 Kg/cm², and a molding time ranging from 60-180 seconds

Since each polyurethane elastomer film 22 penetrates into the fabric sheet 21 and reacts with the surface agent to form a —CONH bonding therebetween, each thermoplastic sheet 23 can be firmly bonded to the fabric sheet 21. In addition, by hot pressing the stack according to the method of this invention, the long waiting time for drying the adhesive as required in making the conventional composite laminate and the presence of bubbles are eliminated.

With the invention thus explained, it is apparent that various modifications and variations can be made without departing from the spirit of the present invention.

What is claimed is:

1. A composite laminate comprising:
a fabric sheet which is surface-treated with an amine-containing surface agent;
a thermoplastic sheet having a thickness ranging from 0.5 to 3 mm; and
a polyurethane elastomer film interposed between said fabric sheet and said thermoplastic sheet, and penetrating into and through said fabric sheet so as to react with said surface agent on said fabric sheet and so as to be bonded to said thermoplastic sheet in an amount such that said composite laminate has a Barcol's hardness ranging from HBI-A6 to HBI-A16, a flexure strength ranging from, 30 to 250 N/mm², a flexure modulus ranging from 700 to 5000 N/mm², and an impact resistance ranging from 100 to 800 J/m.

2. The composite laminate of claim 1, wherein said thermoplastic sheet is made from a material selected from the group consisting of polyvinyl chloride, acrylonitrile-butadiene-styrene copolymer, polystyrene, polycarbonate, and polyester.

3. The composite laminate of claim 1, wherein said fabric sheet is made from a material selected from the group consisting of carbon fiber and glass fiber.

4. A rigid molded article comprising:
a fabric sheet which is surface-treated with an amine-containing surface agent;
a thermoplastic sheet having a thickness ranging from 0.5 to 3 mm; and
a polyurethane elastomer film interposed between said fabric sheet and said thermoplastic sheet, and penetrating into and through said fabric sheet so as to react with said surface agent on said fabric sheet and so as to be bonded to said thermoplastic sheet in an amount such that said composite laminate has a Barcol's hardness ranging from HBI-A6 to HBI-A16, a flexure strength ranging from 30 to 250 N/mm², a flexure modulus ranging from 700 to 5000 N/mm², and an impact resistance ranging from 100 to 800 J/m.
